(19) United States
(12) Patent Application Publication
(10) Pub. No.: US 2004/0242261 A1
(43) Pub. Date: Dec. 2, 2004

(54) Software-defined radio

(75) Inventor: Bruce Alan Fette, Mesa, AZ (US)

Correspondence Address: Kenneth A. Nelson, Bryan Cave LLP, Suite 2200, Two North Central Avenue, Phoenix, AZ, 85004-4406, US

(73) Assignee: General Dynamics Decision Systems, Inc.

(21) Appl. No.: 10/449,597

(22) Filed: May 29, 2003

(51) Int. Cl. H04M 3/00

(52) U.S. Cl. 455/550.1; 455/418

(57) ABSTRACT

A software-defined radio includes a communications security processor (221) configured to transmit and receive a plurality of waveforms under a plurality of communications standards, and a reconfigurable resource configured to execute a plurality of software programs. Each of the software programs is capable of reconfiguring the reconfigurable resource to emulate one of a plurality of processors to process a portion of the plurality of waveforms under one of the plurality of communications standards. The reconfigurable resource is implemented on a single chip. In one embodiment, the reconfigurable resource is a field programmable gate array (301). In the same or another embodiment, at least one of the plurality of processors is a digital signal processor (400, 500, 700, 1000).

### FIELD OF THE INVENTION

This invention relates generally to radio communications, and relates more particularly to software-defined radios.

### BACKGROUND OF THE INVENTION

Radios and other communications devices function according to one of several communications standards. Not every communications standard is compatible with every other communications standard, leading to a situation where some communications devices are unable to communicate with other such devices. An example arises in the context of cellular telephones. Many of the cellular telephones used in Europe function according to a communications standard known as the Global System for Mobile Communications (GSM) standard. The GSM standard is based on a technology known as Time Division Multiple Access (TDMA). Many cellular telephones used in North America function according to standards based on Code Division Multiple Access (CDMA) technology. Because the North American and European standards are often not compatible with each other, cellular telephones purchased in North America are often unusable in Europe, and vice versa.

The above example is just one of many examples illustrating the need for a radio or other communications device that is capable of functioning according to multiple communications standards. In other words, there is a need for a device that can process multiple waveforms. A radio wave produced by CDMA technology, for example, may have a different waveform than does a radio wave produced by TDMA technology.

Communications devices known as software-defined radios are capable of creating a very large variety of waveforms, further adding to the issues of incompatibility that exist in communications technology. Some of the waveforms created are so complex that more than one digital signal processor chip is required to process them. Radios having multiple digital signal processor chips can be both bulky and expensive. Referring to FIG. 1, a standard software-defined radio 100 comprises a black data bus 110 a red data bus 120, and an antenna 125. Black data bus 110 connects an analog radio frequency (RF) front end 111, an analog-to-digital and digital-to-analog converter 112, a modem digital signal processor (DSP) 113, and a black host general purpose processor 114 to a communications security processor 121. Red data bus 120 connects communications security processor 121 to a red host general purpose processor 122, a voice encoder (vocoder) DSP 123, and an analog-to-digital/digital-to-analog converter 124. In standard software-defined radios, each of the components mentioned above may be implemented on a separate chip in the software-defined radio, leading to the bulk and expense alluded to earlier herein. Accordingly, there exists a need for a handheld and embedded communications device, and in particular a handheld and embedded software-defined radio, capable of processing multiple waveforms inexpensively and efficiently.

### BRIEF DESCRIPTION OF THE DRAWINGS

The invention will be better understood from a reading of the following detailed description, taken in conjunction with the accompanying figures in the drawings in which:

FIG. 1 is a block diagram of a standard software-defined radio signal processing architecture;

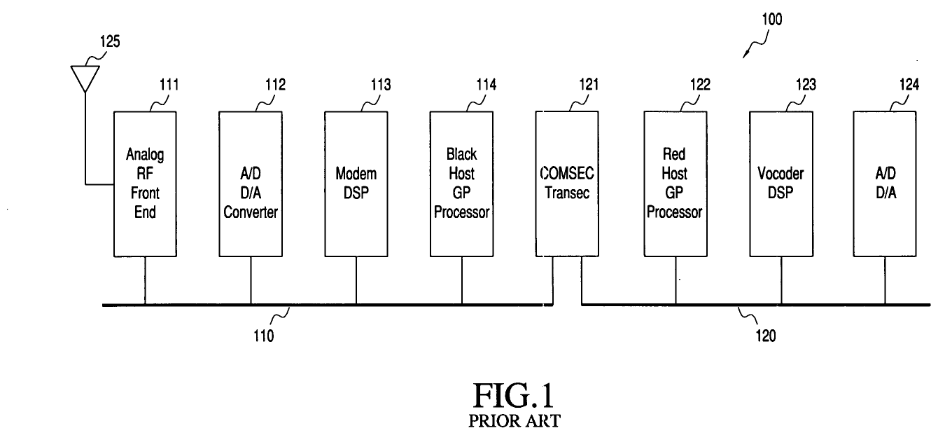

FIG. 2 is a block diagram of a software-defined radio according to an embodiment of the invention;

FIG. 3 is a top view of a portion of a software-defined radio according to an embodiment of the invention;

FIG. 4 is a block diagram of a digital signal processor according to an embodiment of the invention;

FIG. 5 is a block diagram of a digital signal processor according to another embodiment of the invention;

FIG. 6 is a block diagram of a special purpose arithmetic logic unit and a digital signal processor according to an embodiment of the invention;

FIG. 7 is a block diagram of a digital signal processor according to another embodiment of the invention;

FIG. 8 is a block diagram of a context switching process according to an embodiment of the invention;

FIG. 9 is a block diagram showing the logic of a context memory switch according to an embodiment of the invention;

FIG. 10 is a block diagram of multiple cooperating digital signal processor according to another embodiment of the invention; and

FIG. 11 is a block diagram of the digital signal processor of FIG. 10 showing signals flowing through several DSPs, each cooperating to implement a waveform according to another embodiment of the invention.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn with full detail, in order to avoid making the drawings overly complex. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Furthermore, the terms “comprise,” “include,” “have,” and any variations thereof, are intended to cover a non-exclusive inclusion, such that a process, method, article, or apparatus that comprises a list of elements is not necessarily limited to those elements, but may include other elements not expressly listed or inherent to such process, method, article, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein. The term “coupled,” as used herein, is defined as directly or indirectly connected in an electrical or non-electrical manner.

### DETAILED DESCRIPTION OF THE DRAWINGS

In an embodiment of the invention disclosed herein, a software-defined radio comprises a transceiver configured to transmit and receive a plurality of waveforms under a plurality of communications standards, and a reconfigurable resource which can be dynamically reconfigured to execute a plurality of software programs. Each of the software programs is capable of reconfiguring the reconfigurable resource to emulate one of a plurality of processors to process a portion of the plurality of waveforms under one of the plurality of communications standards. The reconfigurable resource is implemented on a single chip. In one embodiment, the reconfigurable resource comprises a field programmable gate array (FPGA). In a particular embodiment, the reconfigurable resource comprises an FPGA and a general purpose processor. In the same or another embodiment, at least one of the plurality of processors is a DSP.

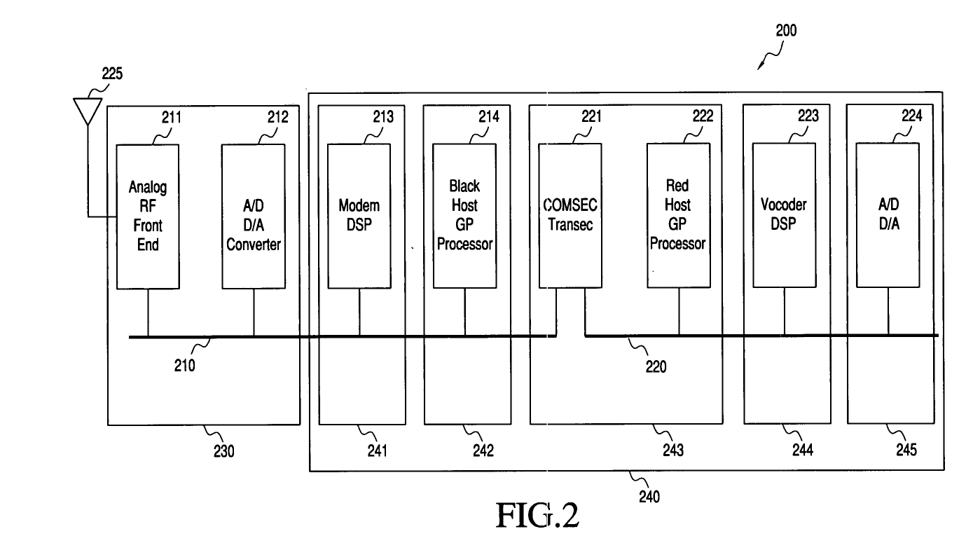

Referring now to FIG. 2, which is a block diagram of a software-defined radio according to an embodiment of the invention, a software-defined radio 200 comprises a black data bus 210, a red data bus 220, and an antenna 225. As is known in the art, in at least one embodiment black data bus 210 carries data that have been encrypted, while red data bus 220 carries data that have not been encrypted. Black data bus 210 may be used to move a signal from an analog RF front end 211 through an analog-to-digital and digital-to-analog converter 212, a modem DSP 213, and a black host general purpose processor 214, and into a communications security processor 221. In one embodiment, black data bus 210 may also carry a control signal that carries information pertaining to, for example, sample rate, frequency, waveform, and error correcting coding needed by one or more of analog RF front end 211, analog-to-digital and digital-to-analog converter 212, modem DSP 213, black host general purpose processor 214, and communications security processor 221. In another embodiment, the control signal may be carried by a separate data bus. Red data bus 220 may move a signal from an analog-to-digital/digital-to-analog converter 224 through a vocoder DSP 223, and a red host general purpose processor 222, and into communications security processor 221. Red data bus 220 may carry a control signal similar to the control signal that may be carried by black data bus 210. In another embodiment, the control signal may be carried by a separate data bus.

Software-defined radio 200 further comprises a portion 230 and a portion 240. Portion 230 comprises analog RF front end 211 and analog-to-digital and digital-to-analog converter 212, and may be implemented in software-defined radio 200 by using an existing card containing those components. In one embodiment, portion 230 can be integrated with portion 240 as a custom device. In the same or another embodiment, portion 230 comprises a transceiver.

Portion 240 can be a single FPGA implemented on a single chip. As an example, the FPGA can be a 10 million-gate FPGA that can be reloaded for each waveform. Reloading the FPGA for each waveform means that the FPGA only needs to implement what is used in that waveform. Portion 240 comprises a section 241, a section 242, a section 243, a section 244, and a section 245. Section 241 comprises modem DSP 213. If desired, modem DSP 213 may be augmented with multiple hardware signal processing building blocks. Section 242 comprises black host general purpose processor 214. Section 243 comprises communications security processor 221 and red host general purpose processor 222. In one embodiment, communications security processor 221 and red host general purpose processor 222 can be implemented using an architecture similar to the Advanced Infosec Machine (AIM) described in U.S. Pat. No. 5,365,591, U.S. Pat. No. 6,026,490, U.S. Pat. No. 6,081,896, U.S. Pat. No. 6,101,255, or other similar configurable cryptographic processor-like architecture. Section 244 comprises vocoder DSP 223. If desired, vocoder DSP 223 may be augmented with hardware signal processing building blocks. Section 245 comprises analog-to-digital/digital-to-analog converter 224. In one embodiment, analog-to-digital/digital-to-analog converter 224 can comprise a sigma-delta design.

As an example, communications security processor 221 can be configured to encrypt and decrypt data associated with a plurality of waveforms under a plurality of communications standards. Portion 240 can be an FPGA integrated circuit configured to implement a plurality of digital signal processors. Each digital signal processor can further be configured by software programs, wherein each of the software programs are capable of emulating one of a plurality of processors to process a portion of the plurality of waveforms under one of the plurality of communications standards. Furthermore, the Instruction Set Architecture (ISA) of each processor may be adapted to be particularly efficient for the software processes that the DSP is required to implement for a selected waveform. For example, the ISA may be selected from among one or more standard ISAs for which software and waveform development tools and libraries are available.

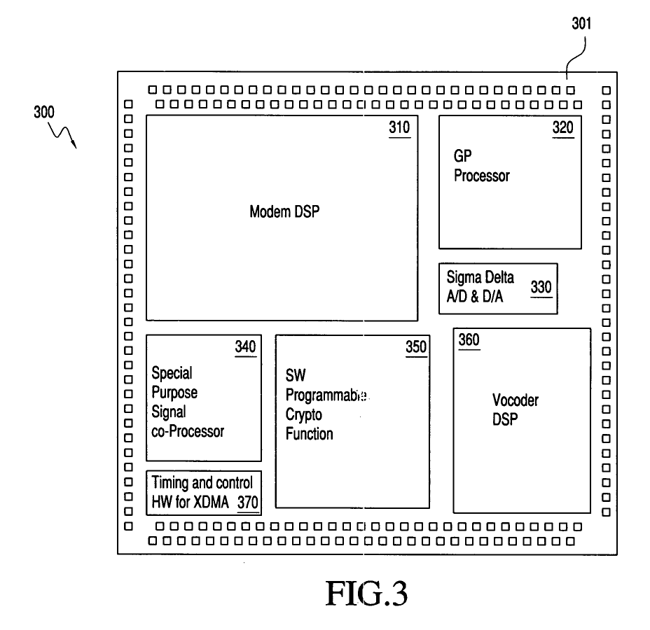

FIG. 3 is a top view of a portion of an FPGA-based software-defined radio according to an embodiment of the invention. Referring to FIG. 3, a software-defined radio 300 is laid out on an FPGA 301. Software-defined radio 300 comprises a modem DSP block 310, a general purpose processor block 320, a sigma delta analog-to-digital/digital-to-analog converter block 330, a special purpose signal co-processor block 340, a software programmable crypto function block 350, a vocoder DSP block 360, and a timing and control hardware block 370. As an example, the configuration illustrated in FIG. 3 may allow the software-defined radio to be implemented in a handheld form factor. As another example, the configuration illustrated in FIG. 3 or another configuration may allow the software-defined radio to be implemented in an embedded form factor wherein the software-defined radio is embedded within another platform, such as a ground or air vehicle, a larger machine or apparatus, or the like.

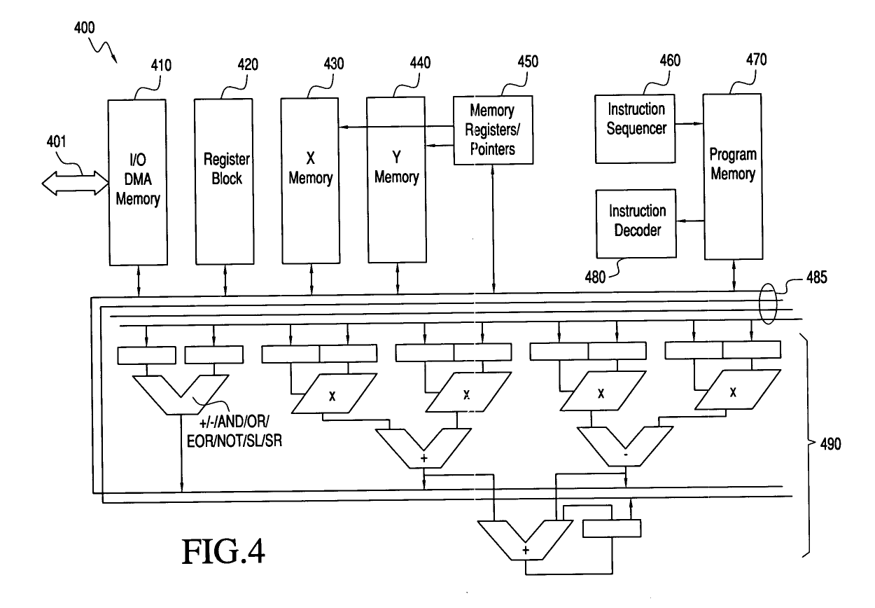

FIG. 4 is a block diagram of a DSP 400 according to an embodiment of the invention. DSP 400 comprises an input/output Direct Memory Access (DMA) Controller and associated input/output DMA memory 410, a register block 420, a memory 430, and a memory 440. DSP 400 further comprises a plurality of memory pointer registers 450, an instruction sequencer 460, a program memory 470, an instruction decoder 480, a bus 485, and a general purpose arithmetic logic unit (ALU) 490. Bus 485 interconnects ALU 490 to input/output DMA memory 410, register block 420, memory 430, memory 440, memory pointer registers 450, and program memory 470. ALU 490 can be configured to match signal processing requirements of at least one of the plurality of waveforms. In one embodiment, ALU 490 and at least one of the plurality of processors, such as, for example, the processor depicted in general purpose processor block 320 in FIG. 3, are capable of performing instructions in parallel with each other. Information flows into and out of input/output DMA memory 410 via a data line 401. Instruction decoder 480 can be programmed to make DSP 400 implement the instruction set architecture of any common DSP processor, where the instruction set architecture may define a standard for performing the sequencing of mathematical and logical instructions to implement at least one of the plurality of waveforms. This functionality of the instruction set architecture allows DSP 400 to use existing waveform software that targets any DSP, meaning the best software tools for any given application can be used. The programming of instruction decoder 480 even extends to real time programming for different processor types, which allows the use of software object libraries coded for DSPs other than DSP 400.

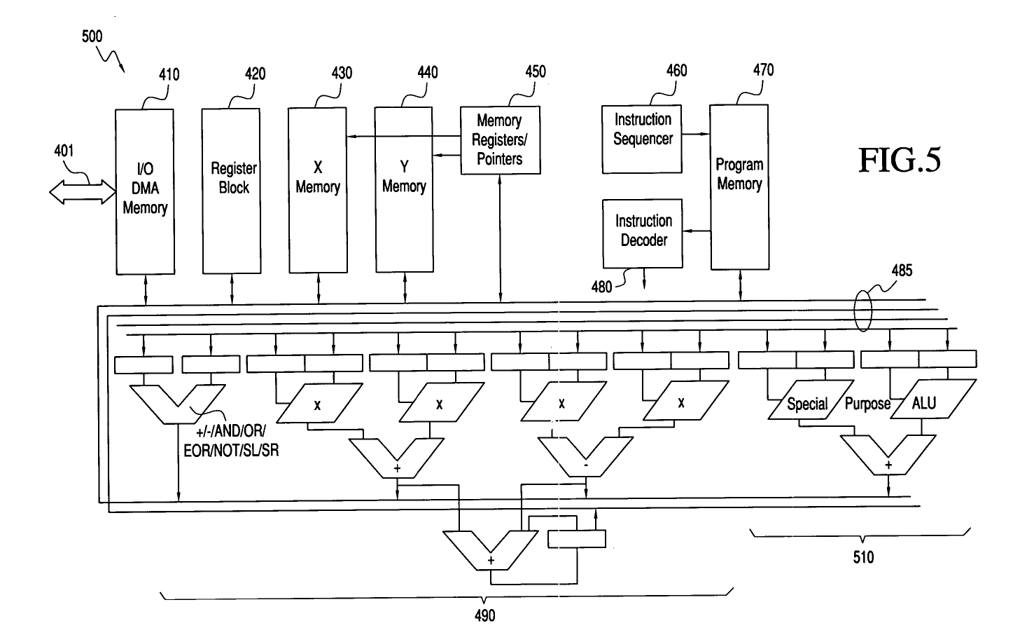

FIG. 5 is a block diagram of a DSP 500 according to an embodiment of the invention. DSP 500 is substantially similar to DSP 400 in FIG. 4. DSP 500, unlike DSP 400, includes a special purpose ALU 510. Special purpose ALU 510 may enable DSP 500 to be more efficient at implementing a particular waveform signal process. As an example, special purpose ALU 510 can be a Viterbi co-processor, a finite impulse response (FIR) filter, an equalizer, a Costas tracking loop, a quantizer/splitter, or some other specialized function needed to demodulate a signal in real time.

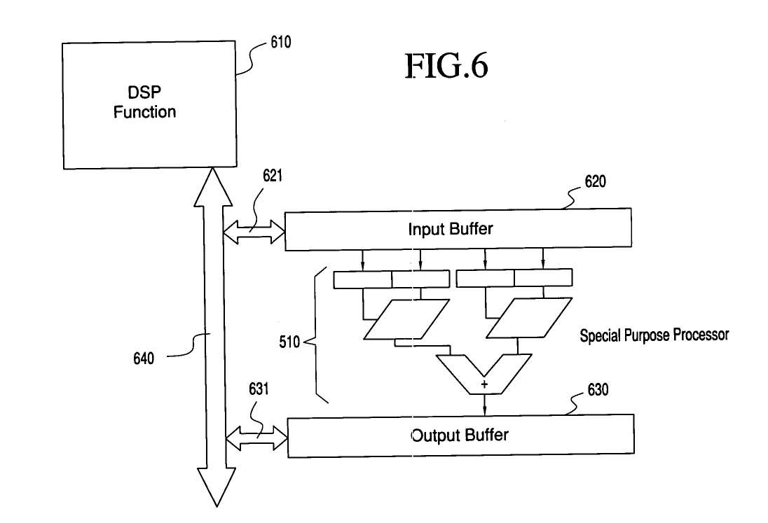

FIG. 6 is a block diagram of a special purpose ALU that serves as a DSP coprocessor according to an embodiment of the invention. A DSP 610 in FIG. 6 communicates via a main DSP bus 640 with an input buffer 620 and an output buffer 630. A link 621 allows data transfer between input buffer 620 and main DSP bus 640, and a link 631 allows data transfer between output buffer 630 and main DSP bus 640. Special purpose ALU 510 supports DSP 610 as a co-processor so that DSP 610 can continue to perform instructions in parallel with special purpose ALU 510. As an example, main DSP bus 640 can be the same as or similar to bus 485 in FIG. 5, and DSP 610 can comprise associated input/output DMA memory 410, register block 420, memory 430, memory 440 memory pointer registers 450, instruction sequencer 460, program memory 470, and instruction decoder 480 in FIG. 5.

In one embodiment, special purpose ALU 510 can be controlled by a programmable micro sequencer, thereby allowing special purpose ALU 510 to be programmed to implement a range of functionality. As an example, special purpose ALU 510 can be programmed to implement a particular number of taps of an FIR filter. As another example, DSP 610 can access a software callable subroutine, which in turn calls a driver. The driver sends data and control parameters to a hardware coprocessor. A special purpose ALU can form part of the hardware coprocessor to make the hardware coprocessor extremely efficient. When finished, the hardware coprocessor returns results via main DSP bus 640 and interrupts with returned data.

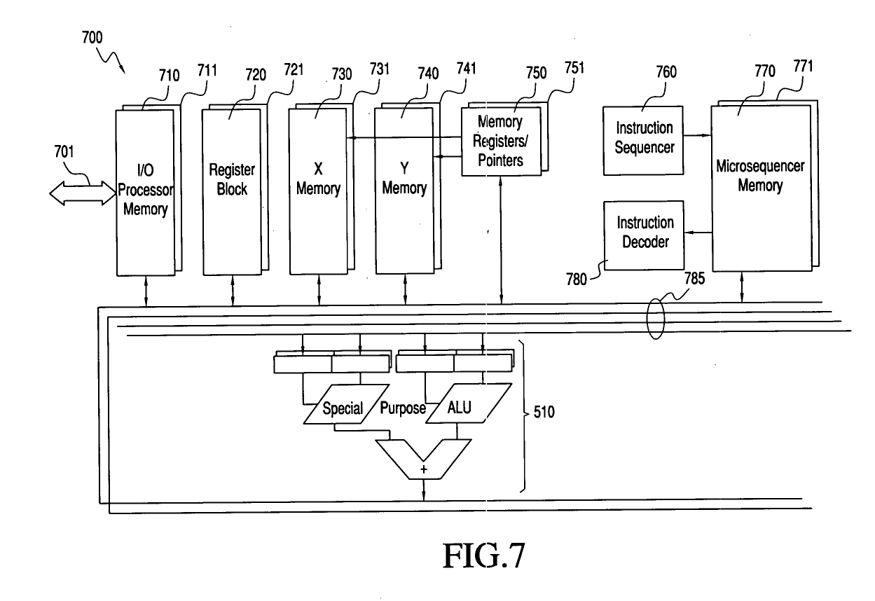

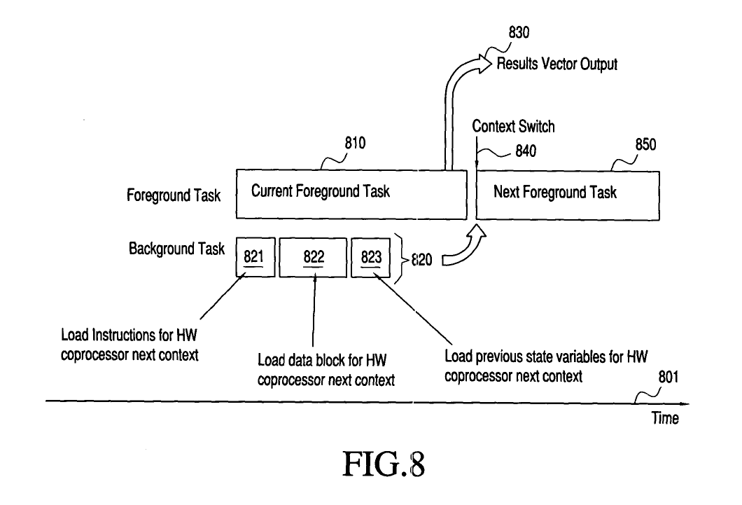

FIG. 7 is a block diagram of a DSP 700 according to another embodiment of the invention. As an example, DSP 700 can be similar to DSP 500 in FIG. 5, where elements 710, 720, 730, 740, 750, 760, 770, 780, and 785 in FIG. 7 are similar to associated input/output DMA memory 410, register block 420, memory 430, memory 440 memory pointer registers 450, instruction sequencer 460, program memory 470, instruction decoder 480, and bus 485, respectively, in FIGS. 4 and 5. It will be noted that ALU 490 is not shown in FIG. 7. DSP 700 includes background memories 711, 721, 731, 741, 751, and 771, which are loaded for the next task while the current task executes. This “context switching” of special purpose ALU 510 allows it to queue tasks and instantly jump to the next task without spending time unloading and reloading memories and registers. Further details of the context switching process are shown in FIG. 8.

Referring now to FIG. 8, which is a block diagram of a context switching process according to an embodiment of the invention, a current foreground task 810 is executed in the processor while the data and instructions for the next task are prepared. When the current foreground task 810 completes, the context is switched to enable the next task to become a foreground task 850. FIG. 8 shows the signal processing elements used with context switching for multi-tasking a specialized signal processing operation. In a step 821, instructions for the hardware coprocessor in the next context are loaded. In a step 822, a data block for the hardware coprocessor in the next context are loaded. In a step 823, previous state variables for the hardware coprocessor in the next context are loaded. The results of current foreground task 810 are output via a results output vector 830. Steps 821, 822, and 823 are followed by a context switch 840, which marks the beginning of next foreground task 850. In one embodiment, a reconfigurable resource, such as FPGA 301 (FIG. 3) can switch context to rapidly perform a sequence of processes on multiple blocks of data.

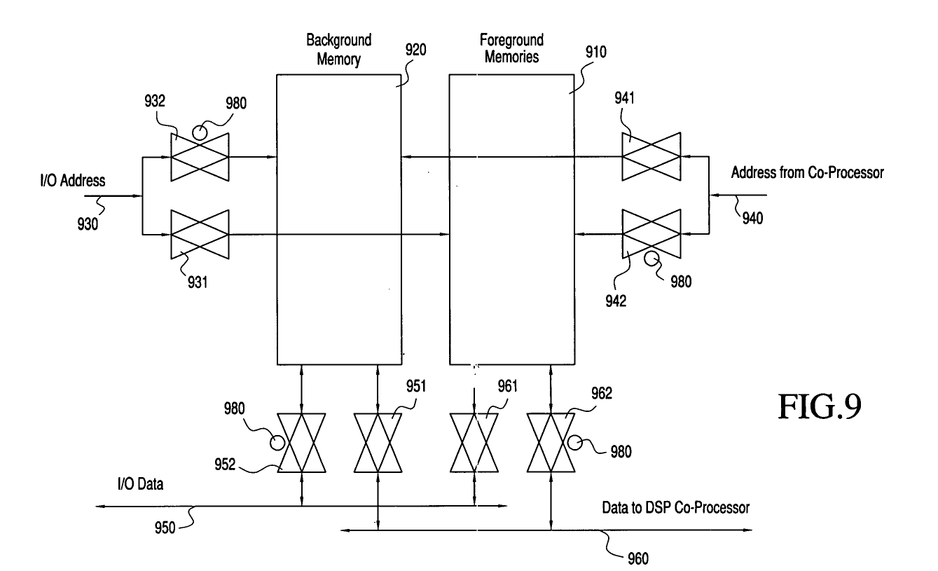

FIG. 9 is a block diagram showing the logic of a context memory switch according to an embodiment of the invention. FIG. 9 illustrates foreground memories 910 and a background memory 920. As an example, background memory 920 can be similar to one or more of background memories 711, 721, 731, 741, 751, and 771 in FIG. 7. An I/O address bus 930 delivers memory address elements to the selectable background memory through memory address selectors 931 and 932 for whichever memory is currently background memory 920. A co-processor address bus 940 delivers memory address elements to whichever memory is currently foreground memory 910 through memory address selectors 941 and 942. Similarly, an I/O data bus 950 delivers memory data through memory address selectors 951 and 952 to background memory 920, and a co-processor data bus 960 delivers memory data through memory address selectors 961 and 962 to foreground memory 910. Circles 980 next to memory address selectors 932, 942, 952, and 962 indicate that memory address selectors 932, 942, 952, and 962 are turned off when memory address selectors 931, 941, 951, and 961 are turned on, and vice versa.

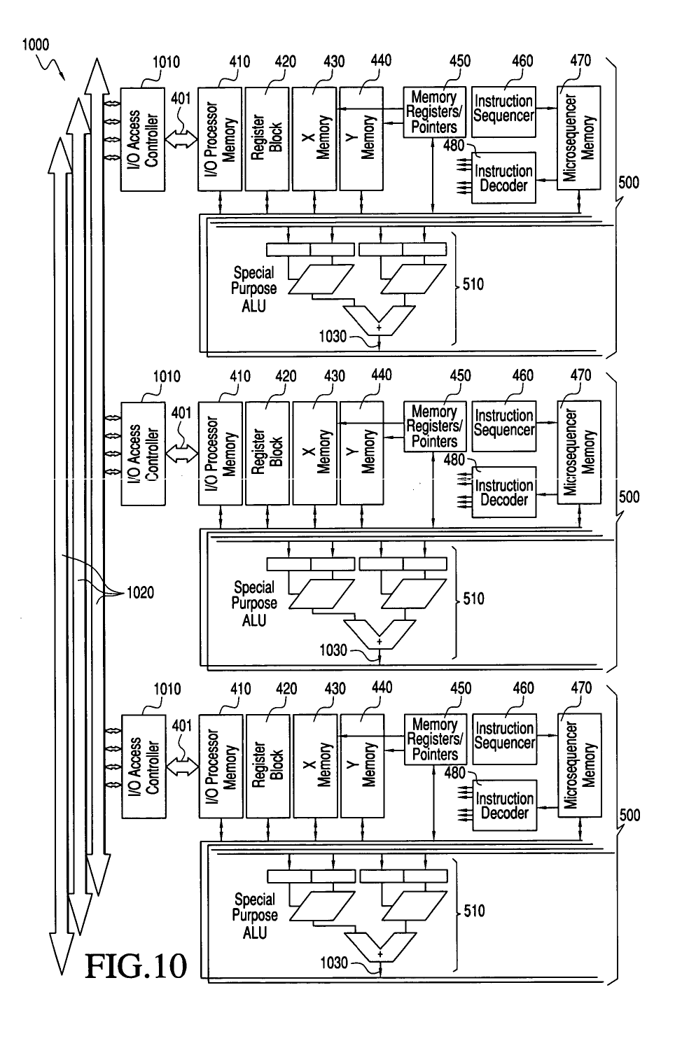

FIG. 10 is a block diagram of a DSP 1000 according to another embodiment of the invention. DSP 1000 comprises a plurality of DSPs 500, each of which include a special purpose ALU 510, as explained above. Arrows 1030 leading from each special purpose ALU 510 indicate a direction of data flow from one special purpose ALU to the next special purpose ALU in sequence according to data packet instructions, which may include a definition of the sequence of operations to be applied to the data. DSP 1000 may include multiple busses 1020 to move data among special purpose ALUs 510. In one embodiment, busses 1020 can be access contention-based so that each one of multiple busses 1020 can support multiple special purpose ALUs. In another embodiment, busses 1020 can be dedicated busses defined specifically for a single waveform. A plurality of I/O access controllers 1010 allow communication between DSPs 500 and busses 1020, via data line 401.

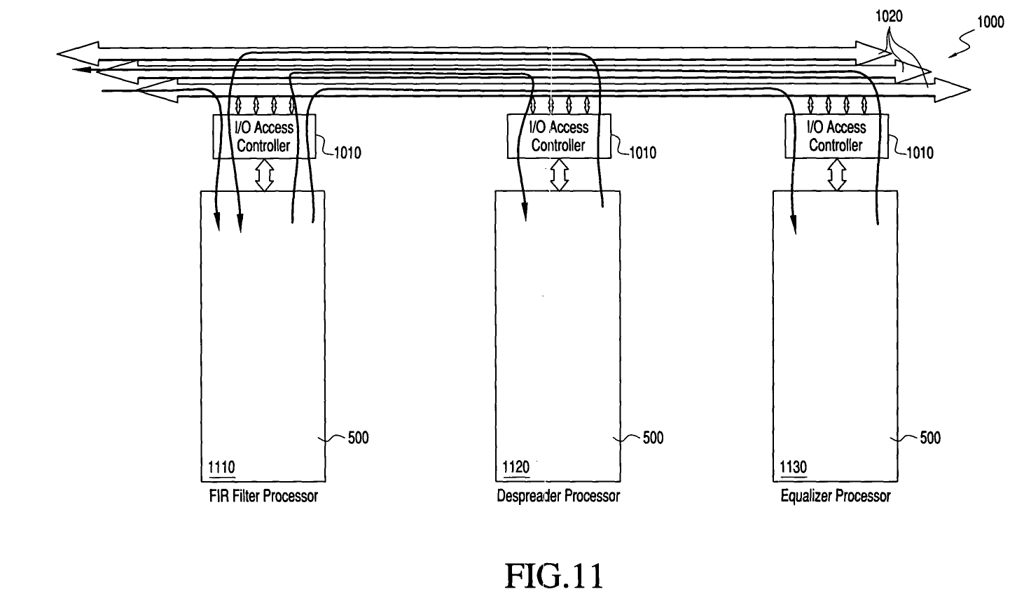

FIG. 11 is a block diagram of DSP 1000 according to another embodiment of the invention. In the embodiment illustrated in FIG. 11, DSPs 500 are: an FIR filter processor 1110; a despreader processor 1120; and an equalizer processor 1130. Because FIR filter processor 1110, despreader processor 1120, and equalizer processor 1130 are each programmable and configurable, each can be used multiple times for a waveform if necessary. As an example, FIR filter processor 1110 can perform multiple FIR filtering operations, each associated with different stages of the transmit or receive signal processes, as orchestrated by DSP 610 (FIG. 6). DSP 610 can further orchestrate the activity of any number of DSP coprocessors, including FIR filter processor 1110, despreader processor 1120, and equalizer processor 1130.

Although the invention has been described with reference to specific embodiments, it will be understood by those skilled in the art to which the invention pertains that various changes may be made without departing from the spirit or scope of the invention. Accordingly, the disclosure of embodiments of the invention is intended to be illustrative of the scope of the invention and is not intended to be limiting. It is intended that the scope of the invention shall be limited only to the extent required by the appended claims. To one of ordinary skill in the art it will be readily apparent that the software-defined radio discussed herein may be implemented in a variety of embodiments, and that the foregoing discussion of certain of these embodiments does not necessarily represent a complete description of all possible embodiments. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims. Moreover, embodiments and limitations disclosed herein are not dedicated to the public under the doctrine of dedication if the embodiments and/or limitations: (1) are not expressly claimed in the claims and (2) are or are potentially equivalents of express elements and/or limitations in the claims under the doctrine of equivalents.

What is claimed is:

1. A software-defined radio comprising:
a transceiver configured to transmit and receive a plurality of waveforms under a plurality of communications standards; and
a reconfigurable resource configured to execute a plurality of software programs, each of the plurality of software programs reconfiguring the reconfigurable resource to emulate one of a plurality of processors to process a portion of the plurality of waveforms under one of the plurality of communications standards,
wherein:
the reconfigurable resource is implemented on a single chip.

2. The software-defined radio of claim 1 wherein:
the reconfigurable resource comprises a field programmable gate array.

3. The software-defined radio of claim 1 wherein:
at least one of the plurality of processors is a digital signal processor.

4. The software-defined radio of claim 1 wherein:
at least one of the plurality of processors is adapted to implement an instruction set architecture;
the instruction set architecture defines a standard for performing sequencing of a plurality of instructions to implement at least one of the plurality of waveforms; and
the reconfigurable resource can switch context to match the instruction set architecture to at least one of the plurality of waveforms.

5. The software-defined radio of claim 4 wherein:
the reconfigurable resource further comprises an arithmetic logic unit.

6. The software-defined radio of claim 5 wherein:
the arithmetic logic unit is configured to match signal processing requirements of at least one of the plurality of waveforms.

7. The software-defined radio of claim 5 wherein:
the arithmetic logic unit and the at least one of the plurality of processors perform instructions in parallel with each other.

8. The software-defined radio of claim 7 wherein:
the arithmetic logic unit is configured to be context switched.

9. The software-defined radio of claim 1 wherein:
the software-defined radio is implemented in a handheld form factor.

10. The software-defined radio of claim 1 wherein:
the software-defined radio is implemented in an embedded form factor.

11. A software-defined radio comprising:
a field programmable gate array capable of being configured as a plurality of software-based digital signal processing units; and
a transceiver,
wherein:
each of the plurality of software-based digital signal processing units are capable of being reconfigured to match signal processing requirements of one of the plurality of waveforms.

12. The software-defined radio of claim 11 wherein:
at least one of the plurality of software-based digital signal processing units is adapted to implement an instruction set architecture;
the instruction set architecture is selected from among one or more standard instruction set architecture standards for handling at least one of the plurality of waveforms; and
the field programmable gate array can switch context to perform a sequence of processes on multiple blocks of data.

13. The software-defined radio of claim 12 wherein:
the field programmable gate array further comprises an arithmetic logic unit.

14. The software-defined radio of claim 13 wherein:
the arithmetic logic unit is configured to match signal processing requirements of at least one of the plurality of waveforms.

15. The software-defined radio of claim 13 wherein:
the arithmetic logic unit and the at least one of the plurality of software-based digital signal processing units perform instructions in parallel with each other.

16. The software-defined radio of claim 15 wherein:
the arithmetic logic unit is configured to be context switched.

17. The software-defined radio of claim 11 wherein:
the software-defined radio is implemented in a handheld form factor.

18. A handheld software-defined radio comprising:
a single-chip field programmable gate array; and
a transceiver adapted to transmit and receive a waveform,
wherein:
the waveform is processed by a plurality of signal processing functions; and
the plurality of signal processing functions are implemented on the single-chip field programmable gate array.

19. The handheld software-defined radio of claim 18 wherein:
at least one of the plurality of signal processing functions is implemented by a digital signal processor.

20. The handheld software-defined radio of claim 19 wherein:
at least one of the plurality of signal processing functions is adapted to implement an instruction set architecture;
the instruction set architecture implements a standard instruction set architecture for which software and waveform development tools and libraries are available; and
the single-chip field programmable gate array can switch context to match the instruction set architecture to the waveform.

21. The handheld software-defined radio of claim 20 wherein:
the single-chip field programmable gate array further comprises an arithmetic logic unit.

22. The handheld software-defined radio of claim 21 wherein:
the arithmetic logic unit is configured to match signal processing requirements of the waveform.

23. The handheld software-defined radio of claim 21 wherein:
the arithmetic logic unit and at least one of the plurality of signal processing functions perform instructions in parallel with each other.

24. The handheld software-defined radio of claim 21 wherein:
the arithmetic logic unit is configured to be context switched.

25. The handheld software-defined radio of claim 18 wherein:
the handheld software-defined radio is implemented in a handheld form factor.
